(19) United States
(12) Patent Application Publication
(10) Pub. No.: US 2026/0117943 A1
(43) Pub. Date: Apr. 30, 2026

(54) DISPENSER DEVICE HAVING PUMP AND ILLUMINATING DEVICE

(71) Applicant: Lona Michelle Cowart, Vestavia Hills, AL (US)

(72) Inventor: Lona Michelle Cowart, Vestavia Hills, AL (US)

(21) Appl. No.: 18/930,655

(22) Filed: Oct. 29, 2024

(51) Int. Cl. F21L 4/08; B05B 11/10; F21V 23/00; F21V 23/04; F21W 111/10; F21W 131/30; F21Y 115/10

(52) U.S. Cl. CPC F21L 4/08; B05B 11/10; F21V 23/003; F21V 23/04; F21W 2111/10; F21W 2131/30; F21Y 2115/10

(57) ABSTRACT

An emblem illuminating dispenser device includes a container having an interior space defining a reservoir configured for holding a substance to be dispensed. An emblem is positioned on the container and a light illuminates the emblem when the light is activated. A pump is coupled to the container for dispensing the substance from the reservoir. An activation switch coupled to the container is operationally coupled to the light. The pump is operationally coupled to the activation switch such that operation of the pump activates the light.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to dispenser devices and more particularly pertains to a new dispenser device for illuminating an emblem on a dispenser device when dispensing from the dispenser device.

### (2) Description of Related Art Including Information Disclosed under 37 CFR 1.97 and 1.98

The prior art relates to dispenser devices which dispense soap or similar substances. Known prior art fails to provide for illumination of an emblem or symbol related to the act of use of the dispenser wherein the illumination of the emblem provides a reminder or affirmation of potential individual or collective significance to the user in association with the act of using the substance dispensed.

### BRIEF SUMMARY OF THE INVENTION

An embodiment of the disclosure meets the needs presented above by generally comprising a container having an interior space defining a reservoir configured for holding a substance to be dispensed. An emblem is positioned on the container and a light illuminates the emblem when the light is activated. A pump is coupled to the container for dispensing the substance from the reservoir. An activation switch coupled to the container is operationally coupled to the light. The pump is operationally coupled to the activation switch such that operation of the pump activates the light.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front bottom side perspective view of an emblem illuminating dispenser device according to an embodiment of the disclosure.

FIG. 2 is a front view of an embodiment of the disclosure.

FIG. 3 is a right side view of an embodiment of the disclosure.

FIG. 4 is a cross-sectional view of an embodiment of the disclosure taken along line 4-4 of FIG. 3.

FIG. 5 is a front side perspective view of an embodiment of the disclosure in use.

### DETAILED DESCRIPTION OF THE INVENTION

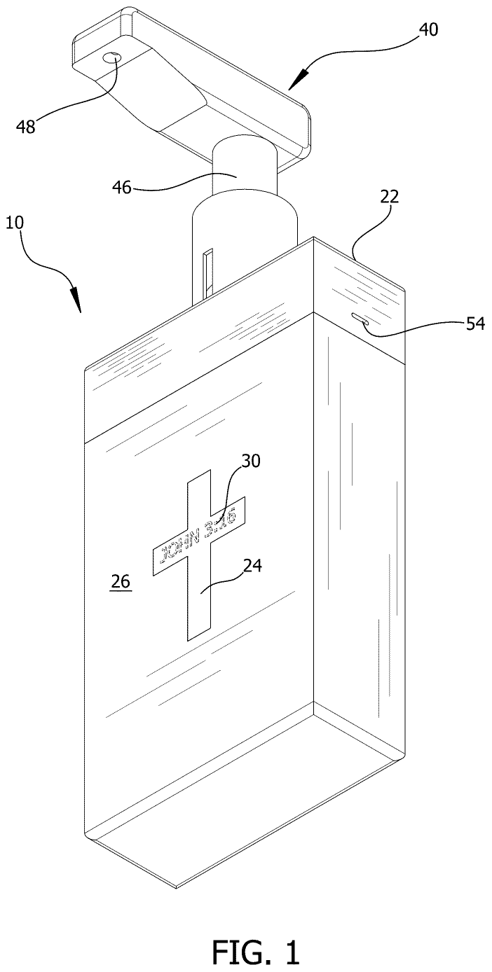

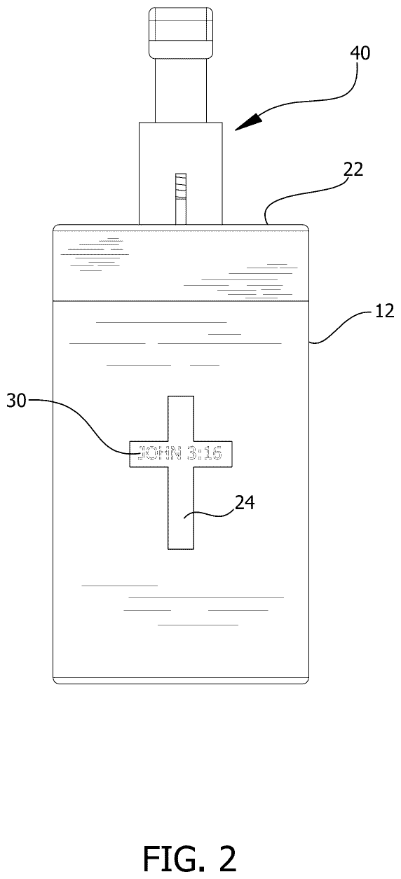

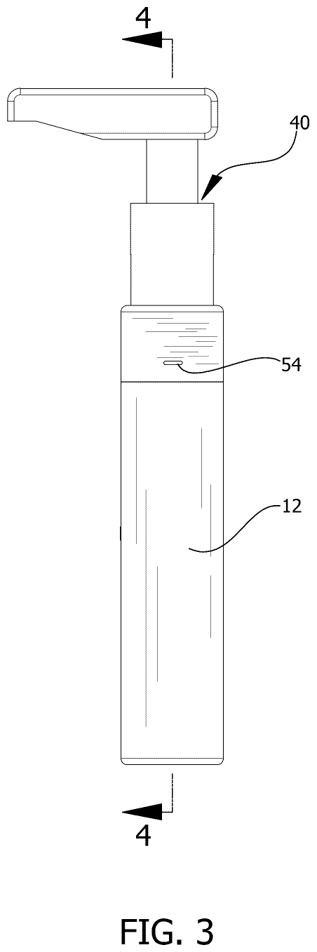

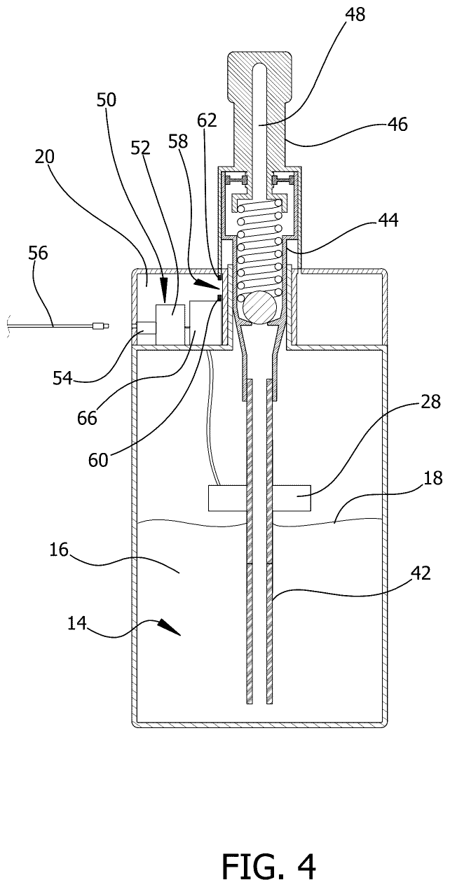

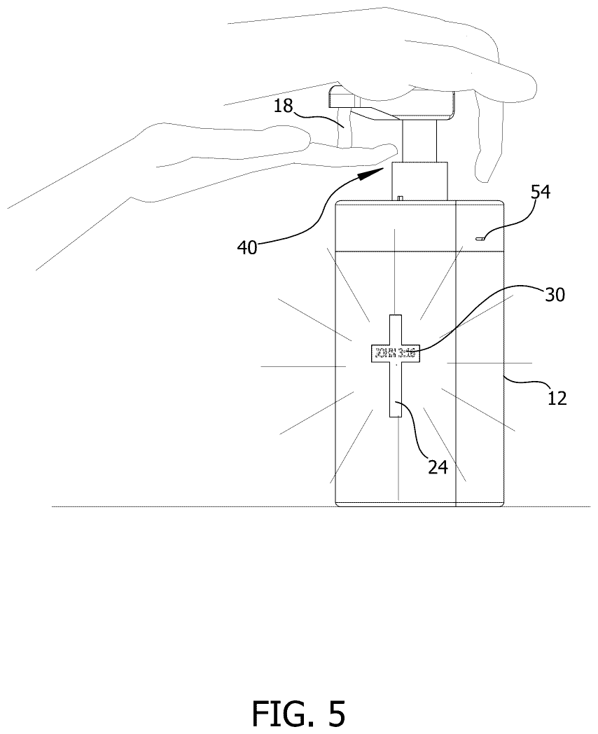

With reference now to the drawings, and in particular to FIGS. 1 through 5 thereof, a new dispenser device embodying the principles and concepts of an embodiment of the disclosure and generally designated by the reference numeral 10 will be described.

As best illustrated in FIGS. 1 through 5, the emblem illuminating dispenser device 10 generally comprises a container 12 having an interior space 14 defining a reservoir 16 configured for holding a substance 18 to be dispensed. The substance 18 may be soap, hand sanitizer, scented lotion or oil, or the like. The container 12 has an interior chamber 20 discrete from the reservoir 16. The interior chamber 20 may be annular extending around a neck 22 in fluid communication with and extending up from the interior space 14. The interior chamber 20 is positioned adjacent to a top 22 of the container 12. An emblem 24 is positioned on the container 12. The emblem 24 may be formed by a panel flush with or either offset or inset relative to an outer surface 26 of the container 12. The emblem 24 is cross-shaped as this shape has significance as a religious symbol. The emblem 24 is translucent. It is contemplated that translucent has not just the common meaning of light transmitting partially through the emblem 24 but that the emblem 24 might also be fully transparent. A light 28 is coupled to the container 12. The light 28 may be a light emitting diode and may have a shape corresponding to a shape of the emblem 24. The light 28 is positioned adjacent to the emblem 24 or the light 28 may be positioned non-adjacent with transmission of illumination being delivered to the emblem 24 through conventional fiber optics, or the like. The light 28 illuminates the emblem 24 when the light 28 is activated. Indicia 30 may be positioned on the emblem 24. The indicia 30 is opaque wherein illumination of the emblem 24 highlights the indicia 30 on the emblem 24 when the light 28 is activated. It is contemplated that the term highlighted means that the emblem 24 is illuminated around the indicia 30 producing an effect much like use of a highlighter produces contrast around writing on a page drawing added attention to the writing. The indicia 30 may be a phrase, or more specifically a chapter and verse having religious significance. Thus, the indicia 30 and shape of the emblem 24 cooperate to bring attention to the religious significance and relate such to the substance 18 being delivered, particularly as the substance is related to mental association with cleanliness. It is contemplated the association of cleanliness and religious significance of the emblem 24 and indicia 30 would enhance the roles individually and collectively of cleanliness and religion in the life of a user.

A pump 40 is coupled to the container 12. The pump 40 is configured for dispensing the substance 18 from the reservoir 16 when attached to the container 12. The pump 40 is of generally conventional design including a tube 42 extending into the reservoir 16 and a funnel valve 44 in fluid communication with the tube 42. A piston 46 is coupled to the funnel valve 44 and is movable relative to the container 12. A dispensing channel 48 extends through the piston 46 such that urging the piston 46 towards the container 12 is configured to dispense the substance 18 from the reservoir 16 through the dispensing channel 48.

A power source 50 is coupled to the container 12. The power source 50 is electrically coupled to the light 28 and may be a rechargeable battery 52. The rechargeable battery 52 may be charged by removal or through use of a charge port 54 coupled to the container 12. The charge port 54 is electrically coupled to the rechargeable battery 52 such that the charge port 54 is configured for connection to a charging cord 56 to charge the rechargeable battery 52 without having to remove it from the interior chamber 20.

An activation switch 58 is coupled to the container 12 and pump 40. The activation switch 58 is electrically coupled between the power source 50 and the light 28. The activation switch 58 is operationally coupled to the light 28 such that the light 28 is activated by operation of the activation switch 58. The pump 40 is operationally coupled to the activation switch 58 as described below wherein operation of the pump 40 activates the light 28. The activation switch 58 includes a fixed contact 60 coupled to the container 12. The fixed contact 60 is positioned within the interior chamber 20. The activation switch 58 further includes a moving contact 62 coupled to the pump 40. The moving contact 62 is moved as the pump 40 is operated so that the moving contact 62 touches the fixed contact 60 when the pump 40 is operated. Thus, the moving contact 62 touches the fixed contact 60 closing the activation switch 58 whereby the light 28 is activated. The moving contact 62 is positioned on the piston 46 wherein the moving contact 62 is urged to touch the fixed contact 60 when the piston 46 is moved towards the container 12.

A processor 66 is positioned in the interior chamber 20 and electrically coupled to the activation switch 58, the power source 50, and the light 28. The processor 66 initiates activation of the light 28 upon closing of the activation switch 58 and maintains activation of the light 28 for a pre-determined duration of time after closing of the activation switch 58. The duration of time may be related to a period of time associated with suggested hand washing practice from dispensing of soap onto the hands until rinsing of soap from the hands.

In use, the pump 40 is attached to the container 12 in conventional fashion such that the activation switch 58 will close upon operation of the pump 40 to dispense the substance 18 from the reservoir 16 of the container 12. The light 28 illuminates the emblem 24 and highlights the indicia 30 providing a visual representation and physical association of religious significance individually and in combination with the act of cleanliness in use of the substance 18 when the substance 18 is related to an act of cleanliness.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An emblem illuminating dispenser device comprising:
a container having an interior space defining a reservoir configured for holding a substance to be dispensed;
an emblem having a fixed shape and being positioned statically on said container;
a light coupled to said container, said light illuminating said emblem when said light is activated;
a pump coupled to said container, said pump being configured for dispensing the substance from the reservoir; and
an activation switch coupled to said container, said activation switch being operationally coupled to said light wherein said light is activated by operation of said activation switch, said pump being operationally coupled to said activation switch wherein operation of said pump activates said light.

2. The emblem illuminating dispenser device of claim 1, further comprising a power source coupled to said container, said power source being electrically coupled to said light, said activation switch being electrically coupled between said power source and said light.

3. The emblem illuminating dispenser device of claim 2, further comprising said power source being a rechargeable battery.

4. The emblem illuminating dispenser device of claim 3, further comprising a charge port coupled to said container, said charge port being electrically coupled to said rechargeable battery wherein said charge port is configured for connection to a charging cord to charge said rechargeable battery.

5. The emblem illuminating dispenser device of claim 1, further comprising said emblem being cross-shaped.

6. The emblem illuminating dispenser device of claim 5, further comprising indicia positioned on said emblem.

7. The emblem illuminating dispenser device of claim 6, further comprising said emblem being translucent and said indicia being opaque wherein illumination of said emblem highlights said indicia on said emblem when said light is activated.

8. The emblem illuminating dispenser device of claim 1, wherein said activation switch comprises:
a fixed contact coupled to said container;
a moving contact coupled to said pump, said moving contact being moved to touch said fixed contact when said pump is operated, wherein said moving contact touching said fixed contact closes said activation switch whereby said light is activated.

9. The emblem illuminating dispenser device of claim 8, further comprising said container having an interior chamber discrete from said reservoir, said interior chamber being positioned adjacent to a top of said container, said fixed contact being positioned within said interior chamber.

10. The emblem illuminating dispenser device of claim 9, wherein said pump comprises:
a tube extending into said reservoir;
a funnel valve in fluid communication with said tube;
a piston coupled to said funnel valve, said piston being movable relative to said container;
a dispensing channel extending through said piston wherein urging said piston towards said container is configured to dispense the substance from the reservoir through the dispensing channel.

11. The emblem illuminating dispenser device of claim 10 wherein said activation switch comprises:
a fixed contact coupled to said container, and
a moving contact coupled to said pump, said moving contact being moved to touch said fixed contact when said pump is operated, wherein said moving contact touching said fixed contact closes said activation switch whereby said light is activate, said moving contact being positioned on said piston wherein said moving contact is urged to touch said fixed contact when said piston is moved towards said container.

12. The emblem illuminating dispenser device of claim 11, further comprising:
a power source coupled to said container, said power source being electrically coupled to said light, said activation switch being electrically coupled between said power source and said light; and
a processor electrically coupled to said activation switch, said power source, and said light, wherein said processor initiates activation of said light upon closing of said activation switch and maintains activation of said light for a pre-determined duration of time after closing of said activation switch.

13. An emblem illuminating dispenser device comprising:
a container having an interior space defining a reservoir configured for holding a substance to be dispensed, said container having an interior chamber discrete from said reservoir, said interior chamber being positioned adjacent to a top of said container;
an emblem having a fixed shape and being positioned statically on said container, said emblem being cross-shaped, said emblem being translucent;
a light coupled to said container, said light illuminating said emblem when said light is activated;
indicia positioned on said emblem, said indicia being opaque wherein illumination of said emblem highlights said indicia on said emblem when said light is activated;
a pump coupled to said container, said pump being configured for dispensing the substance from the reservoir, wherein said pump comprises
a tube extending into said reservoir,
a funnel valve in fluid communication with said tube,
a piston coupled to said funnel valve, said piston being movable relative to said container, and
a dispensing channel extending through said piston wherein urging said piston towards said container is configured to dispense the substance from the reservoir through the dispensing channel;
a power source coupled to said container, said power source being electrically coupled to said light, said power source being a rechargeable battery;
an activation switch coupled to said container, said activation switch being electrically coupled between said power source and said light, said activation switch being operationally coupled to said light wherein said light is activated by operation of said activation switch, said pump being operationally coupled to said activation switch wherein operation of said pump activates said light, wherein said activation switch comprises
a fixed contact coupled to said container, said fixed contact being positioned within said interior chamber, and
a moving contact coupled to said pump, said moving contact being moved to touch said fixed contact when said pump is operated, wherein said moving contact touching said fixed contact closes said activation switch whereby said light is activated, said moving contact being positioned on said piston wherein said moving contact is urged to touch said fixed contact when said piston is moved towards said container;
a charge port coupled to said container, said charge port being electrically coupled to said rechargeable battery wherein said charge port is configured for connection to a charging cord to charge said rechargeable battery; and
a processor electrically coupled to said activation switch, said power source, and said light, wherein said processor initiates activation of said light upon closing of said activation switch and maintains activation of said light for a pre-determined duration of time after closing of said activation switch.
